(19) United States
(12) Patent Application Publication
(10) Pub. No.: US 2025/0220138 A1
(43) Pub. Date: Jul. 3, 2025

(54) VIDEO CONFERENCING TRANSPARENT PROJECTION SCREEN WITH AN INTEGRATED BEHIND-DISPLAY CAMERA

(71) Applicant: Veeo Technology, Inc., San Diego, CA (US)

(72) Inventors: Ji Shen, San Diego, CA (US); Fenggang Wu, Los Vegas, NV (US); Bruce Barnes, Escondido, CA (US)

(73) Assignee: Veeo Technology, Inc., San Diego, CA (US)

(21) Appl. No.: 18/642,421

(22) Filed: Apr. 22, 2024

Related U.S. Application Data
(63) Continuation-in-part of application No. 18/403,200, filed on Jan. 3, 2024.

(51) Int. Cl. H04N 7/15; G02B 5/30; H04N 5/74; H04N 7/14

(52) U.S. Cl. CPC H04N 7/15; G02B 5/30; H04N 5/74; H04N 7/147

(57) ABSTRACT

A system for video conferencing comprises a video projector and a transparent projection screen of clear material. A behind-display camera captures a video image through the transparent projection screen of a user located on the front side of the screen. To optimize the brightness of the projected video image (as viewed by the user) while preventing the behind-display camera from capturing that same projected video image transmitted through the screen, a series of optical layers in the form of films and/or coatings are included in the optical path between the projector and the camera. The series of optical layers may comprise a first linear polarizer, a partially reflective layer or dispersion layer, and a second linear polarizer. The first and second linear polarizers are orthogonal to one another, i.e., their axes are oriented 90 degrees to one another to block the projected image from being received by the camera. In a front projection arrangement, the partially reflective layer is designed to reflect a bright projected image to the user while permitting ambient light on the user's side to transmit to the camera. In a rear projection arrangement, the dispersion layer is designed to transmit a bright projected image to the user while permitting ambient light on the user's side to transmit through to the camera.

### CROSS-REFERENCE TO RELATED APPLICATION

This patent application claims priority to and is a continuation-in-part of U.S. patent application Ser. No. 18/403,200, filed Jan. 3, 2024, and entitled “Video Conferencing Transparent Monitor with an Integrated Behind-Display Camera,” the entire disclosure of which is incorporated by reference herein.

### BACKGROUND OF THE INVENTION

### 1. Field of Invention

The invention relates to a transparent digital display screen with a behind-display camera and techniques for creating video captured through the transparent digital display screen.

### 2. Description of Related Art

Video conferencing has become an essential technology for business. Users seeing each other in an online meeting using webcams helps build connection and rapport. Typically, a webcam is located at the top center of a display screen's bezel. This configuration allows individuals to conduct a videoconference where each participant's computer captures a video, which is sent to the other participants. The participants, usually at remote locations, view each other while conversing. A common problem is that the videos give the impression that each participant is looking below the camera because they typically look at what is displayed on the screen, not the camera. This detracts from the experience because of the lack of “eye-to-eye” contact.

To make an online video conference a more natural experience, like a real-life in-person meeting, the webcams need to be located at the center of a screen, not in the bevel above the screen. However, when the camera is placed at the front center of the screen, it blocks the content displayed. Thus, it is highly desirable to position the camera behind the display screen on the back side but at the center, being able to look through the display screen with an unobstructed view. It is essential in this configuration that the digital content displayed on the screen and the screen's internal components do not appear in the camera's field of view (FOV). Such a camera configuration could capture an image of a person in front of the display.

A challenge of using a camera behind the display screen is that conventional display screens are not sufficiently transparent. Unlike a transparent sheet of glass, today's display technologies require millions of pixels physically mounted on a glass substrate where the pixel constructs introduce varying opacity to impede light from getting through adequately. In the case of a thin film transistor (TFT) based liquid crystal display (LCD) screen, which is transparent to a degree, a person in front can see through the screen at objects behind that are well illuminated. However, a camera behind the display can only receive approximately ten percent (10%) of the light from the front. Display pixels with light-emitting diodes (LED) or organic light-emitting diodes (OLED) typically require opaque elements, and today's flat panel displays necessitate a high resolution to achieve the highest level of image clarity. As a result, digital display screen surfaces are densely populated with nontransparent pixels. A display screen that is transparent as clear glass and can display high-resolution content is impractical, if not impossible. Several companies have developed transparent OLED (T.OLED) displays, but finding practical applications has been difficult. LG Display has achieved forty percent (40%) transparency for its T.OLED. It is the world's only manufacturer of large-size T.OLED panels, commercializing a 55-inch high-definition T.OLED display.

Smartphone manufacturers have made numerous attempts to position a camera behind a display screen. For example, U.S. Pat. No. 11,294,422 by Apple discloses a screen divided into regions with different resolutions for each region. Because the objective of the latest and greatest smartphone is to put as many pixels in the display screen as possible to increase the resolution, pixels are sparsely placed at only a particular portion of the display surface where the camera is placed behind to let more light through. Pixel resolution significantly decreases at the portion where the camera is located. This may be why all current implementations of a behind-screen camera are placed at the top edge of the screen instead of the center, as having the lowered resolution portion at the screen's center would stand out and degrade the user experience. Another characteristic of a behind-screen camera for mobile phones is that the camera is placed near or in contact with the screen's back surface. This configuration minimizes the number of opaque pixels in the camera's field of view, making correcting the distortion caused by such pixels easier. However, having a dedicated lower-resolution portion of the screen is not desirable. It dramatically complicates manufacturing and increases the cost significantly while not offering more than just aesthetic benefits in industrial design.

U.S. Pat. No. 9,001,184 by Samsung teaches positioning a camera behind a transparent display that alternates the pixel matrix between on and off periods while synchronized with a camera. The camera captures an image when the display is off and does not capture an image when the display is on. The alternating periods are measured by two or three frames. The transparent period of not having an output image on the display is considered as displaying black frames because the pixel matrix emits no light. Yet, the inventors of the present invention have found this technique insufficient. Display screens refresh onscreen and scan in a line-by-line or dot-by-dot manner. As all display screens refresh at a high frequency to minimize response time, especially for displaying high-action content such as video games or movies, as soon as one frame of the screen is completely refreshed, the first scan line of the next frame would need to refresh immediately. There is no period where a single frame is a black frame entirely or cleanly, and no image is displayed unless power is shut off to the TFT transistors for every black frame. A complete power shutoff is impractical. For most regular commercially available transparent screens, such as a T.OLED, when a camera attempts to capture an image during a black frame, there will always be remaining lines of pixels that have not been refreshed to black yet.

When creating a behind-the-display camera in conjunction with a transparent display panel, the inventors discovered the most difficult challenge is to overcome the reflection of light emitted from the light-emitting pixels from the nontransparent portion of a pixel. When transmitted through the transparent portions to the back of the display, such reflection is captured by the behind-display camera as a ghost image of the display content. In the ideal use case, a behind-display camera should not “see” any content displayed on the screen and should only see through the screen to capture the person in front. There is also interference when reflected light rays penetrate the adjacent transparent apertures, creating a Moiré pattern. Without treatment, the camera captures the ghost image and the Moiré light interference pattern. Both are undesirable.

Furthermore, with the millions of pixels entirely laid out in an active matrix formation, the opaque portion of the pixels form rows and columns resembling a mesh or a grid. Depending on the specific size and orientation of the pixel placement, grid lines can be thicker or thinner, leading to distortions that are often heavier or stronger along vertical or horizontal directions. A mesh or grid lines distort the image captured from behind the display. It is imperative to eliminate such distortions so that the image appears clear as if captured with a camera through a sheet of glass.

Holographic-like systems utilize projectors and transparent display screens such as Mylar or metal coated meshes for the display of media content to large audiences. However, these systems suffer from unwanted image bleed through, among other things, which is the transmission or display of a secondary image that appears on the side of the display screen opposite from the projector. The secondary image can be distracting for an audience and prevents adoption in video conferencing applications.

In today's video conferencing systems such as Microsoft Teams, Zoom, and others, the presenting party must use a screen share feature when presenting digital content. At the same time, the camera's view of the person is reduced to a thumbnail on a sidebar or at a corner. The presenter's gaze or gesture is either ignored or is misaligned even when viewed. Such a separated display of the person from the digital content is disorienting for the audience on the remote end. There is a need to embed the presenter's camera view with the on-screen digital content so that the audience can see what the presenter is looking at and where the presenter is pointing, along with the presenter's facial expression and body gestures. Existing video conferencing and online collaborative communications systems are inadequate in addressing such needs.

### SUMMARY OF THE INVENTION

The present invention overcomes these and other deficiencies of the prior art by providing a system for video conferencing comprising a video projector and a transparent projection screen of clear material. A behind-display camera captures a video image through the transparent projection screen of a user located on the front side of the screen. To optimize the brightness of the projected video image (as viewed by the user) while preventing the behind-display camera from capturing that same projected video image transmitted through the screen, a series of optical layers in the form of films and/or coatings are included in the optical path between the projector and the camera. The series of optical layers may comprise a first linear polarizer, a partially reflective layer or dispersion layer, and a second linear polarizer. The first and second linear polarizers are orthogonal to one another, i.e., their axes are oriented 90 degrees to one another to block the projected image from being received by the camera. In a front projection arrangement, the partially reflective layer is designed to reflect a bright projected image to the user while permitting ambient light on the user's side to transmit to the camera. In a rear projection arrangement, the dispersion layer is designed to transmit a bright projected image to the user while permitting ambient light on the user's side to transmit through to the camera

In an embodiment of the invention, a system for video conferencing and collaborative communication comprises: a transparent display screen, a projector disposed on a front side or rear side of the display screen, a camera disposed on a rear side of the display screen, and a controller that synchronizes light projected by the projector with a sensor of the camera. The sensor of the camera is a rolling shutter configured to open and capture one scan line of the light projected by the projector. The light projected by the projector refreshes at a rate of at least 70 Hz. The light projected by the projector comprises a black frame inserted every 14 ms or less. The sensor of the camera is opened every 14 ms or less in synchronization with the black frame inserted every 14 ms or less. The controller controls a frequency of the light projected by the projector and a frequency and a duration of an opening of the sensor of the camera.

In another embodiment of the invention, a system for video conferencing and collaborative communication comprises: a transparent display screen, a projector disposed on a rear side of the display screen, a camera display on the rear side of the display screen, and a controller configures to synchronize the projector's black line insertion with a sensor of the camera. The sensor is a rolling shutter configured to open and capture one scan line of the light projected by the projector. The light projected by the projector comprises a black frame inserted every 14 ms or less. The sensor of the camera is opened every 14 ms or less in synchronization with the black frame inserted every 14 ms or less. The controller controls a frequency of the light projected by the projector and a frequency and a duration of an opening of the sensor of the camera.

In yet another embodiment of the invention, a system for video conferencing and collaborative communication comprises: a transparent display screen, a projector disposed on a rear side of the transparent display screen, a camera disposed on the rear side of the transparent display screen, a first polarized filter disposed between the transparent display screen and the projector, a second polarized filter disposed between the camera and the transparent display screen, wherein the first polarized filter's transmitting axis is perpendicular to the second polarized filter's transmitting axis. The camera comprises a rolling shutter, an opening of which is synchronized with the projector. The transparent display screen is a passive material. The transparent display screen has a transparency of at least 25%. The rolling shutter is operated to permit the camera to capture images at a rate of at least 70 frames per second. The projector is configured to project light comprising a progressive scan with one or more black lines synchronized with a corresponding position of the rolling shutter. The system may further comprise a processor configured to apply a filter, in a frequency domain, to a Y-channel of an image captured by the camera during insertion of the one or more black lines.

In another embodiment of the invention, a system for video conferencing and collaborative communication comprises: a transparent display screen, a projector disposed on a back side or a rear side of the transparent display screen, a camera disposed on the rear side of the transparent display screen, a first polarized filter disposed between the projector and the transparent display screen, and a second polarized filter disposed between the camera and the transparent display screen, wherein the first polarized filter's transmitting axis is perpendicular to the second polarized filter's transmitting axis. The camera comprises a rolling shutter, an opening of which is synchronized with the projector. The transparent display screen is a passive material. The transparent display screen has a transparency of at least 25%. The rolling shutter is operated to permit the camera to capture images at a rate of at least 70 frames per second. The projector is configured to project light comprising a progressive scan with one or more black lines synchronized with a corresponding position of the rolling shutter. The system may further comprise a processor configured to apply a filter, in a frequency domain, to a Y-channel of an image captured by the camera during insertion of the one or more black lines.

The foregoing and other features and advantages of the invention will be apparent from the following more detailed description of the invention's preferred embodiments, as shown in the accompanying drawings and the claims.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a prior art system that uses alternating opaque and transparent display phases to synchronize with a camera's global shutter's opening and closing.

FIG. 2 illustrates a progressive line-by-line refreshing cycle of a display.

FIG. 3 illustrates a typical construct of a T.OLED pixel and the layout of opaque and transparent pixel sections.

FIG. 4 illustrates a microscopic view of the layout of pixels in a T.OLED display screen and the formation of a mesh pattern that distorts camera views.

FIG. 5 illustrates how the display's cover glass reflects the light emitted by the T-OLED pixels and creates a Moiré patterned interference and ghost image.

FIG. 5A is an unprocessed photo captured by a behind-display camera where the ghost image interferes with the camera image of the person in front.

FIG. 6 illustrates when a line of pixels' color is turned black, and there is no ghost image or Moiré pattern interference.

FIG. 6A is an image the behind-display camera captures when removing Moiré pattern interference.

FIG. 7 illustrates how the present invention synchronizes the progressive movement of a rolling shutter of a camera sensor with the progressive line-by-line refresh of the display in front of it.

FIG. 7A is an image the behind-display camera captures when Moiré pattern interference is removed.

FIG. 8A illustrates the present invention.

FIG. 8B illustrates the system of the present invention with input and output ports.

FIG. 9 illustrates the method of the Moiré pattern interference according to an embodiment of the invention.

FIG. 10 illustrates the method of removal of the distortion from a mesh pattern using spatial filtering.

FIG. 11 illustrates the details of the spatial filtering method of the present invention.

FIG. 12 illustrates the frequency domain pattern distribution of mesh interference after performing an FFT.

FIG. 13 illustrates formulating a bandpass filter in the frequency domain to remove a vertical mesh pattern interference according to an embodiment of the invention.

FIG. 14 illustrates formulating a bandpass filter to remove a slanted mesh pattern interference in the frequency domain.

FIG. 15 illustrates creating a correction image and the application of the correction image.

FIG. 15B is a processed photo after removing the Moiré and mesh pattern interference.

FIG. 16 illustrates the construction of a person and digital content embedded in a view image.

FIG. 17 illustrates the effect of disposing the behind-display camera at varying distances from the back of the display.

FIG. 18 illustrates a digital teleprompter with the system of the present invention.

FIG. 19 illustrates enabling the system of the present invention as a second monitor of an external content source device like a computer.

FIG. 20 illustrates the method of enabling the system of the current invention to connect to a host terminal device as a webcam.

FIG. 21 illustrates the video conferencing and collaborative communications system using a virtual glass-like shared glass board.

FIG. 22 illustrates the method using the system of the present invention for video conferencing and collaborative communications using a virtual glass-like shared glass board.

FIG. 23 illustrates a front projection transparent display system according to an embodiment of the invention.

FIG. 24 illustrates a rear projection transparent display system according to an embodiment of the invention.

FIG. 25 illustrates the front projection transparent display system of FIG. 23 with polarizers according to an embodiment of the invention.

FIG. 26 illustrates the rear projection transparent display system of FIG. 24 with polarizers according to an embodiment of the invention.

FIG. 27 illustrates a dispersion layer according to an embodiment of the invention.

### DETAILED DESCRIPTION OF PREFERRED EMBODIMENTS

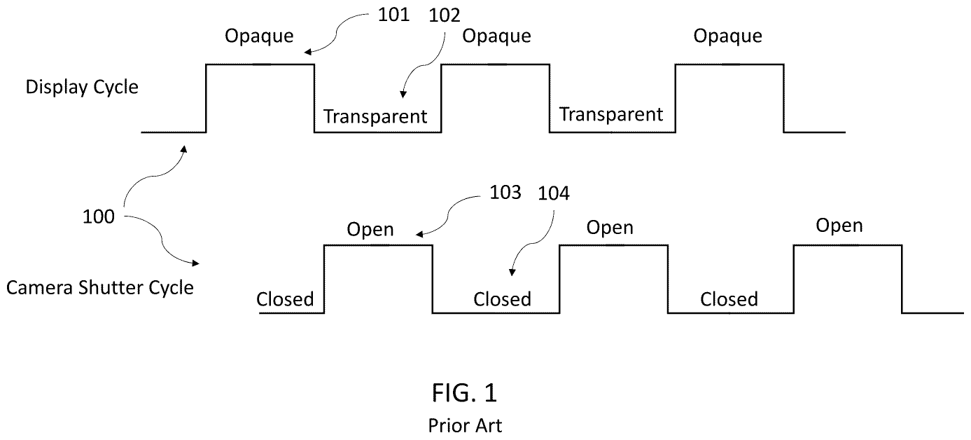

Preferred embodiments of the present invention and their advantages may be understood by referring to FIGS. 1-27. The described features, structures, or characteristics of the invention may be combined in any suitable manner in one or more embodiments. It will be apparent to those skilled in the art that various modifications can be made to the present invention without departing from its spirit and scope. Thus, the current invention is intended to cover modifications and variations consistent with the scope of the appended claims and their equivalents.

While the present invention is discussed in the context of capturing video of a person positioned in front of a transparent display, the present invention can be utilized without a person in front of the transparent display. As used herein, the scope of the term “transparent” includes semi-transparent. For example, the transparency of transparent OLED or T.OLED displays is forty percent (40%), but it is considered transparent. Accordingly, any present or future display portrayed as transparent is sufficiently transparent for use in the present invention, regardless of its actual degree of transparency. For this invention, a display with a transparency of fifteen percent (15%) or more is considered transparent.

FIG. 1 illustrates a prior art technique for capturing video through a transparent display. In this technique, the display operates through cycles of opaque frames 101 when the active matrix of LEDs is on and transparent frames 102 when the active matrix is off, and the camera shutter goes through synchronized cycles of open shutter frames 103 and closed shutter frames 104. This makes it purportedly possible for the camera only to capture images when the display is in its transparent display mode. As it may seem reasonable in theory, that is not how displays work in practice. The inventors can not find any commercially available displays that operate in such a manner.

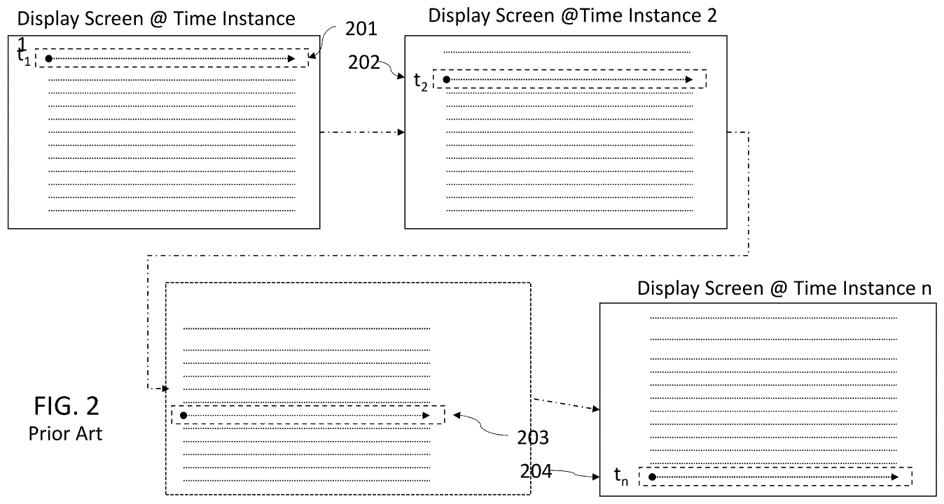

FIG. 2 illustrates that displays like T.OLED progressively refresh each line of pixels on the display. For example, at time instance, t₁, the first line of pixels 201 is refreshed with a new set of colors for the new frame of the image to be displayed. At time instance, t₂, the second line of pixels 202 is refreshed with a new set of colors for the new frame of the image to be displayed. This refresh process repeats line by line until the last line of pixels 204 at time instance t₁ is refreshed, where n is the total number of vertical scan lines in a frame based on the display's resolution specification. For a 720P resolution display, n=720. In slow motion, the refresh process progressing from the top to bottom lines of pixels appears similar to the scan lines of an old cathode ray tube (CRT) TV monitor with lines of phosphorescent pixels glowing by an electron beam to display various color and brightness values at a pixel, then one line of pixels, then all the pixel lines progressively. This means that if one were to use a camera sensor with a global shutter, there is never a time when the whole display screen is turned black, with the exception during the instance between two frames, e.g., 11 μs or 11 microseconds, calculated for a display with 120 Hz refresh rate and 720P resolution as 1 second/120 Hz/720 scan lines≈11.5 μs. However, capturing images at a shutter speed faster than several milliseconds is impractical. 11.5 μs is not enough time for a sensor with a global shutter to capture a frame of image. The prior art teachings are inconsistent with the current state of the art for commercial display products. Short of utilizing a custom-made display that can turn off all pixels at once for multiple milliseconds, it is practical to use the progressive fashion of pixel line refresh on T.OLED displays.

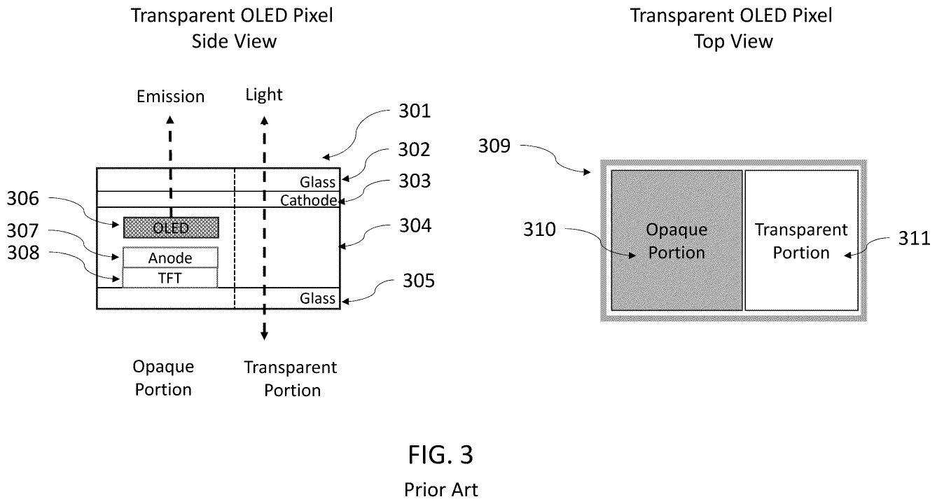

FIG. 3 illustrates a single pixel of a T.OLED display in a top-down view. The whole pixel 301 in the side view comprises two sections, a transparent section 311 and an opaque section 310. The components of the inner workings of a T.OLED display are readily understood by one of ordinary skill in the art and, therefore, not described. To understand the present invention, one of ordinary skill in the art recognizes the pixel stack of OLED 306, anode 307, and TFT 308, which produce the light for the display, also block light from going through the display and are, therefore, considered an opaque optical path. Yet, in the transparent section 311, glass 302, cathode 303, gap 304, and glass 305 are all transparent materials. A T.OLED display is considered transparent because of the transparent section 311 at each pixel. The opaque section 310 remains opaque regardless of the color emitted from the OLED component 306. Even when all the power is cut to the pixel, and no light emits from OLED 306, the opaque section 310 remains opaque. A T.OLED display is, therefore, always considered transparent because a portion of each pixel remains transparent.

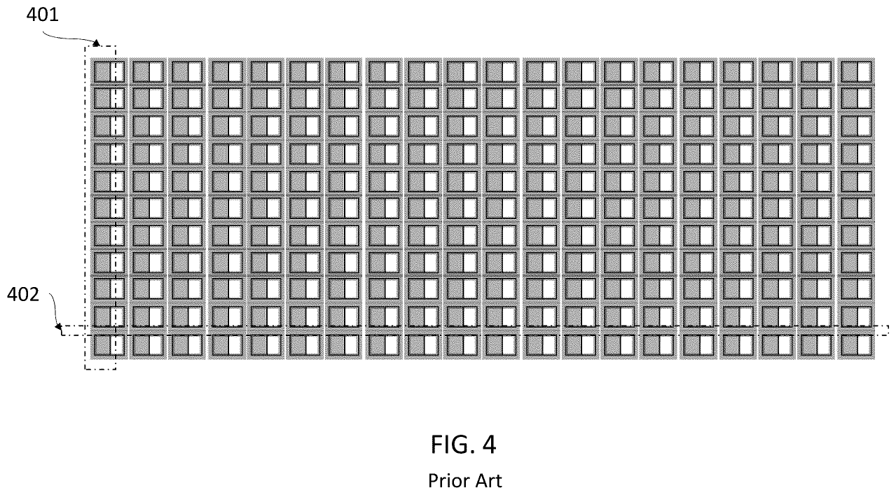

FIG. 4 illustrates the pixel layout in a T.OLED transparent display. In this active matrix formation, the nontransparent opaque section of each pixel is shown in 310 of FIG. 3 and collectively create a layer of a mesh-like structure obstructing and distorting light transmission from the front to the back for the camera disposed behind the display. In particular, for an LG-manufactured T.OLED display, column 401 appears as a heavier vertical pattern and causes more distortion for light than row 402 of gaps between pixels. Such mesh patterns influence the type of distortion correction technique required. It is conceivable that a manufacturer can lay out pixels differently than shown, changing distortion patterns caused by the mesh structure.

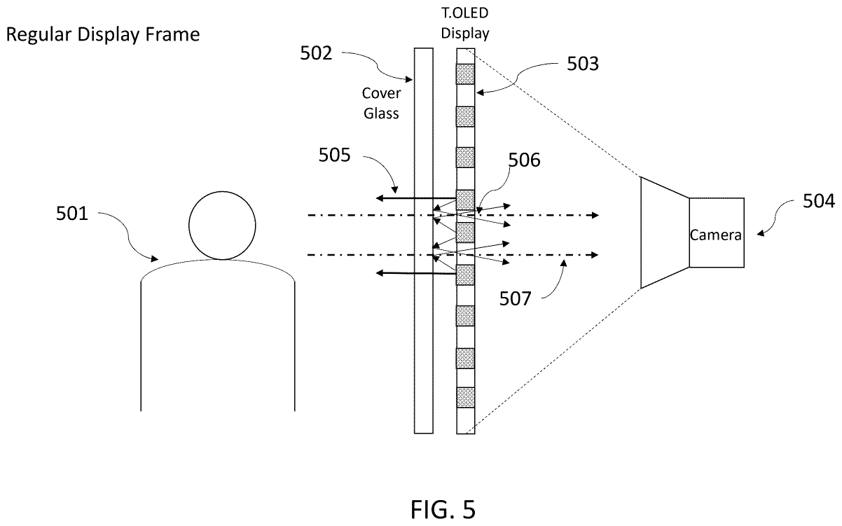

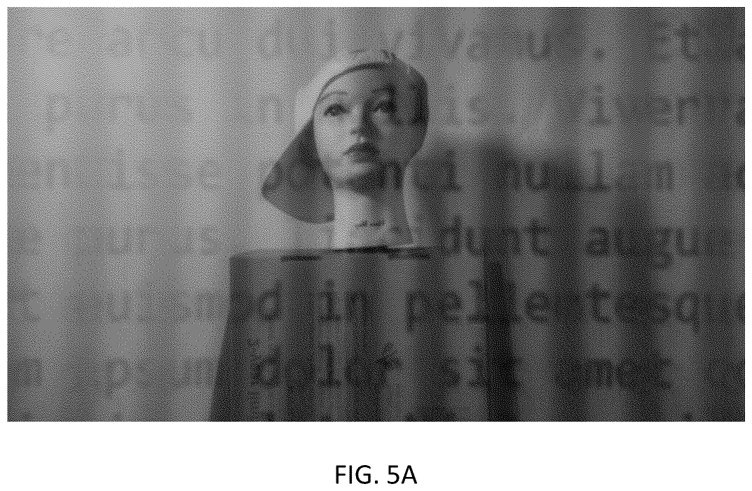

FIG. 5 illustrates how the cover glass for a T.OLED display creates optical interference. The T.OLED display layer 503 has a certain number of pixels depending on its resolution. To protect the T.OLED pixels, a protective cover glass 502 is included. When a pixel emits light 505 transmitting from the pixel to the person 501 in front of the display, the cover glass 502 reflects some of the light 505 backward as light 506 to the camera 504 behind the display through the transparent apertures 311. When these light waves 506 reach the camera's sensor plane, the interaction between these light waves creates a ripple, forming a Moiré pattern. The reflected light waves 506 also create a distorted ghost image captured by the camera 504. The Moiré pattern and distorted ghost image are the most critical distortions to remove. FIG. 5A is a picture of a manikin in front of a T.OLED display captured by a camera behind the display's backside without removing the interference from the reflected and distorted optical pattern or Moiré pattern. As shown in the picture, the ghost image of the digital content (in this instance, text) displayed on the front side of the T.OLED display is present.

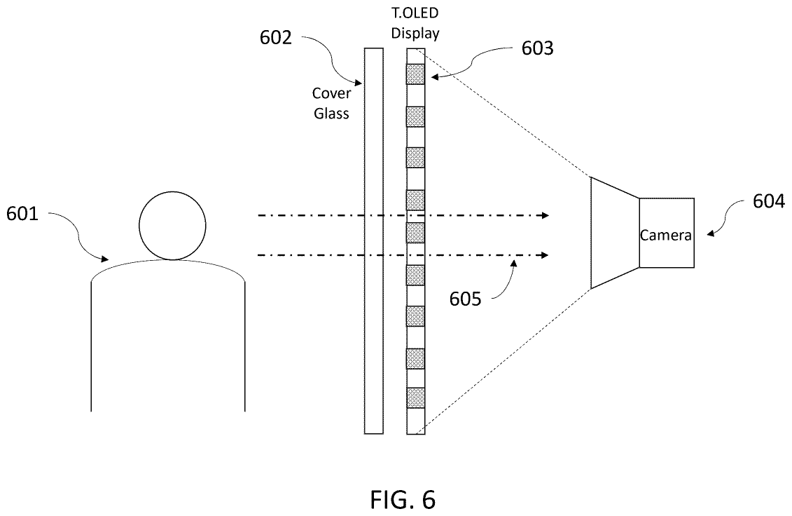

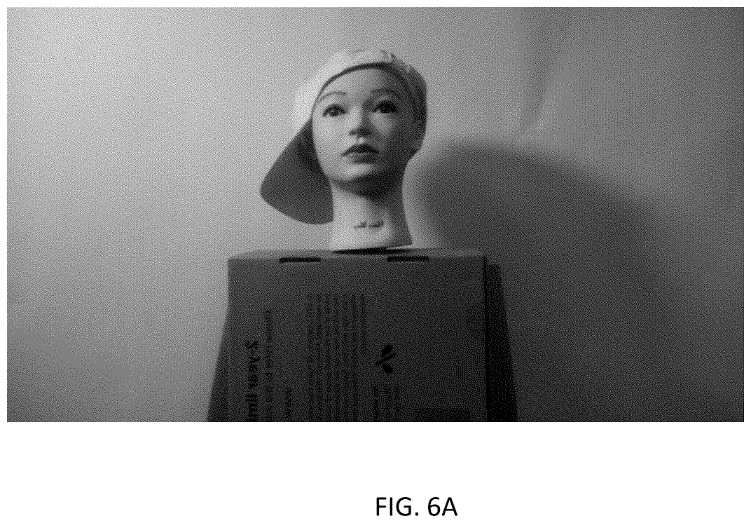

In contrast, FIG. 6 illustrates when T.OLED pixels 603 are not emitting light to the front of the display, the cover glass 602 does not reflect light backward, and therefore, the Moiré pattern interference does not appear in the camera's captured image. Only regular light 605 from the person in front of the display transmits backward to the camera disposed behind the display. FIG. 6A is an image captured by the camera disposed behind the T.OLED display when the display is completely turned off. In this case, none of the T.OLED pixels 603 emitted light to the front, and no light was reflected backward. The picture is free of interference from the Moiré pattern. However, the T.OLED is not as transparent as a clear sheet of glass, and it is apparent that distortion caused by the pixel mesh is still present. The present invention removes all distortion from the picture so that a human can not distinguish between the invention's corrected image and an image captured through a clear sheet of glass.

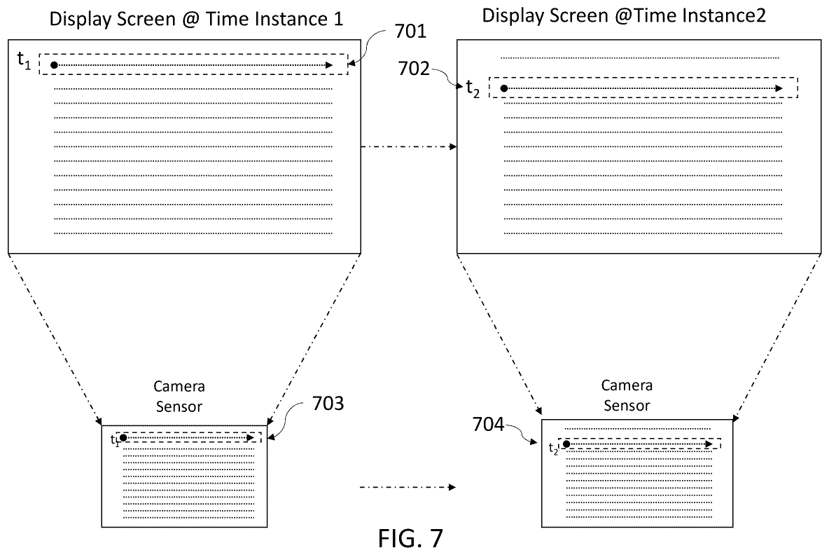

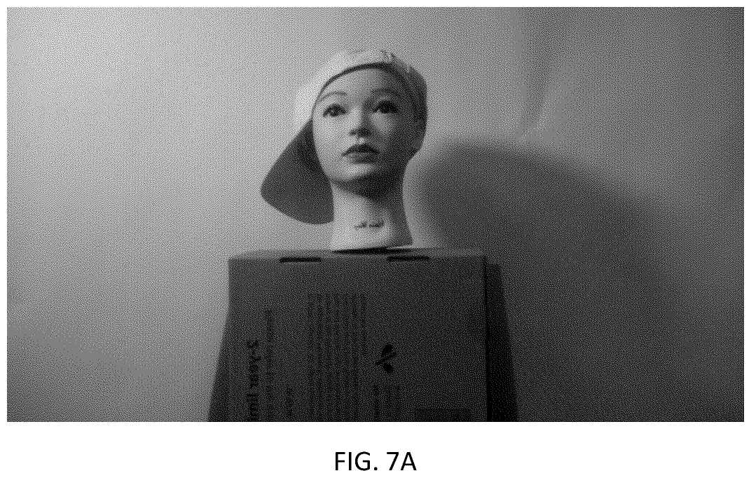

FIG. 7 illustrates a technique to eliminate the Moiré pattern interference according to an embodiment of the invention. Here, the black pixel line refresh is synchronized with the movement of the camera's rolling shutter opening so that the camera sensor only exposes a line of sensor pixels to capture a line of the image of a person in front of the display when the corresponding line of display pixels is turned black. At time instance t₁, display pixel line 701 is refreshed to color black, and in synchronicity, sensor scan line 703 is opened by the rolling shutter control. At this time instance, there is light emitting from the display pixels in line 701, and no light will be reflected backward by the cover glass; the camera sensor captures light 605 transmitting from the front to the back without interference of the Moiré pattern, nor see any reflected ghost image of the digital content on the display.

In this method, the T.OLED display is required to refresh at least at 120 Hz, meaning it can finish refreshing an entire image frame of pixels within 8.33 ms per frame (=1 sec/120 fps), or 11.5 μs per line (=8.33 ms/720). This high refresh rate is necessary to ensure human eyes do not perceive any black pixel lines causing flashing or flickering on the display. The camera sensor must capture and transmit at a speed of 60 frames per second while exposure time (not including data processing, buffering, and transmitting delays) for scanning a full frame of pixel lines must finish within 6 ms to 7 ms. This ensures that when a line of black pixels is present for the duration of 11.5 μs, the sensor's rolling shutter finishes scanning or exposing a sensor pixel line within the same period. For a 1080P resolution display and a matching 1080P resolution camera sensor, it is conceivable the camera sensor must scan faster, finishing sensor scanning per line within 7.7 μs. FIG. 7A is a picture of a manikin model in front of a T.OLED display captured by a camera disposed behind the display on the backside. The black pixel lines of the display were refreshed in synchronization with the rolling shutter opening of sensor pixel scan lines, effectively removing any ghost image or Moiré pattern interference.

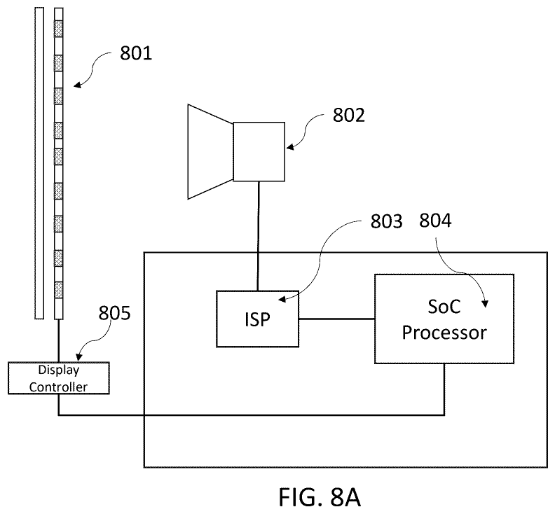

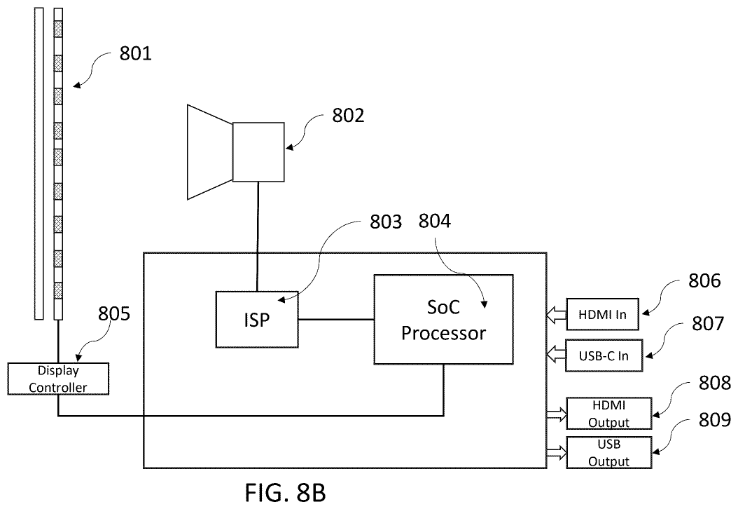

FIG. 8A illustrates a transparent display system according to an embodiment of the invention. The system comprises a camera 802 disposed positioned behind, i.e., rear of, a transparent display 801 along the display's center axis on its back side and a processor 804, which may take the form of a system on a chip (SoC). The center axis is the axis that traverses perpendicularly through the center of the display area. Within the scope of this invention, the camera can also be positioned off the center axis and directed toward the center of the display area in alternative embodiments, preferably with the entire display screen within the camera's field of view. The captured video in such an angular placement can be corrected using optics or digital signal processing. Most displays come with a built-in display controller 805, and most cameras need to work with an image signal processor (ISP) 803, but these components are beyond the scope of the present invention.

FIG. 8B illustrates an alternative embodiment of the transparent display system. In addition to the system shown in FIG. 8A, the system may include any combination of ports such as but not limited to USB3 or USB2 807, an HDMI in port 806, an HDMI out port 808, and a USB OTG output port 809. The addition of input and output connectivity allows for the system to connect with an external content source device or an external host terminal device, enabling the system to be used as a second monitor, a digital teleprompter, a peripheral device like a webcam, or a collaborative communications device with a shared virtual glass board within a video conferencing context.

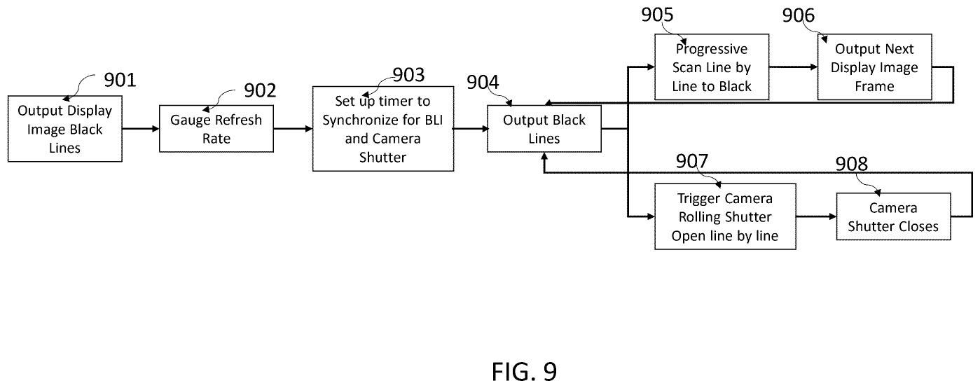

FIG. 9 illustrates a method for black line insertion synchronized with a camera sensor's rolling shutter line-by-line scanning to remove the ghost image and Moiré pattern interference. At step 901, the system's processor outputs a batch of black lines to the display to measure the elapsed time for refreshing a single line of pixels. At step 902, the processor gauges the display's refresh rate by using a photo-sensitive diode sensor or measuring the time to finish a full frame of pixels on the display and/or the beginning and ending times to refresh each pixel line. The timing information is used subsequently to set a timer to synchronize black line insertion (BLI) and camera rolling shutter movement in step 903. The processor outputs BLI in between two display frames in step 904. The display initiates a line-by-line refresh of pixels to black in step 905, and when the refresh is finished for a full screen of pixels, the processor outputs a frame of the display image in step 906. When step 906 is complete, the process loops back to step 904. Simultaneous to step 905, the processor sends a trigger signal in step 907 based on the timer to the camera shutter control interface, such as a GPIO port or I2C port to open the rolling shutter to scan line by line matched in space and time to capture images when the black line by black line is refreshed on the display. When all the pixel lines are refreshed, and the camera's shutter has finished scanning all sensor scan lines, the shutter closes in step 908, then repeats by waiting for step 904 to start again.

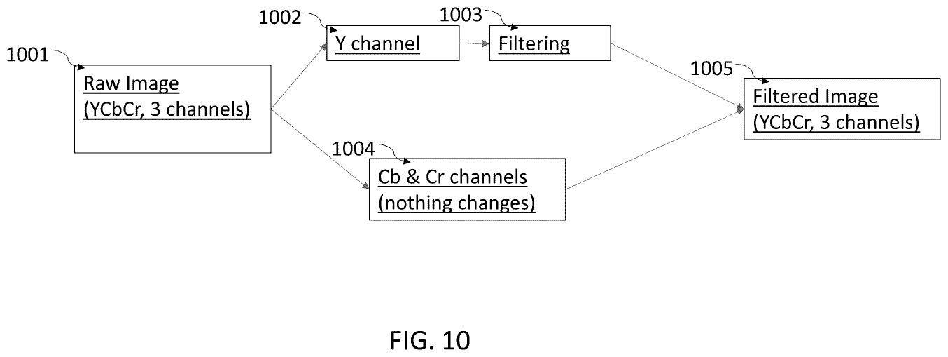

FIG. 10 illustrates a method for raw image encoding, Y channel filtering, and image correction to produce the final filtered image according to an embodiment of the invention. This method eliminates the distortion created by the pixel mesh structure. At step 1001, the raw image data captured by the behind-display camera is encoded into the YCbCr color space. Mesh distortion largely influences the Y channel, which encodes light intensity or brightness information. The Y channel is isolated in step 1002, and spatial filtering is performed on the Y channel in step 1003. The Cb and Cr channels are left unchanged at 1004. After filtering the Y channel, the filtered Y channel data is recombined with the Cb and Cr channels to create a filtered image at 1005. By filtering only the Y channel, without performing any filtering on the other two channels, Cb and Cr, the present invention effectively eliminates the distortion caused by the mesh pattern with a savings factor of three in computation.

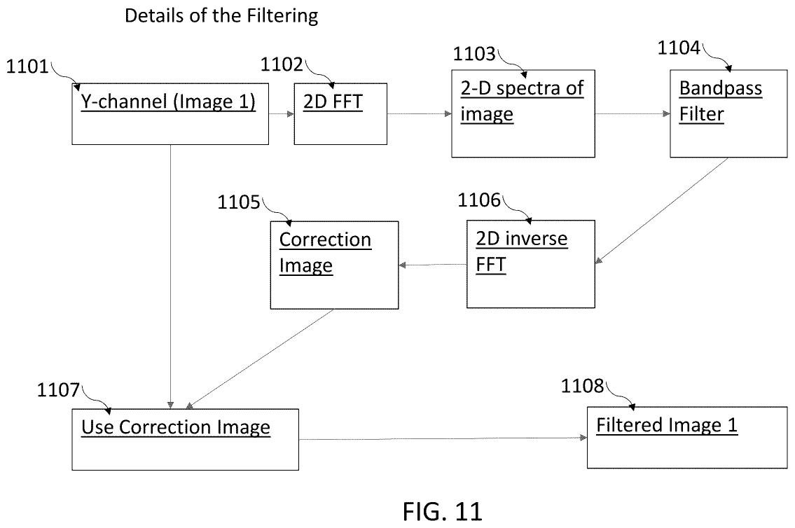

FIG. 11 illustrates a method for creating the Y channel filter, expanding the inner workings of step 1003 above. A two-dimensional fast Fourier transformation (2D FFT) is performed at step 1102 against the Y channel image data 1101. As a result, the FFT transformation produces 2-D spectra of the Y channel image at step 1103. The signature profile frequency distribution pattern in the 2-D spectra is identified in step 1103. Subsequently, a bandpass filter isolating the frequency distribution profile is created in step 1104. After eliminating every other frequency outside of the bandpass filter, the filtered spectra undergo a 2D inverse FFT in 1106, which transforms the frequency profile back to the spatial domain of the Y channel. The resulting spatial domain image from the 2D inverse FFT of step 1106 is the correction image 1105, capturing the spatial domain profile of the mesh structure. Using the correction image of 1105 as the offset against the Y channel raw image at step 1107 results in the filtered image of step 1108, eliminating the distortion of the mesh.

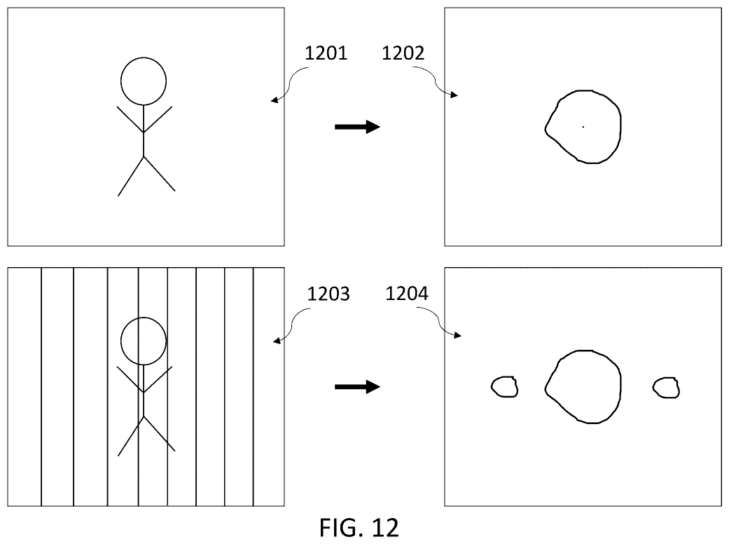

FIG. 12 illustrates when a person is in front of a clear sheet of glass in 1201, the captured image transformed with a 2D FFT results in a spectra profile in the frequency domain, specifically near the center (0,0) point of the spectra, similar to the picture 1202. When a person is in front of a display with a vertical pattern mesh structure, the resulting 2D FFT transformation of image 1203 appears similar to picture 1204, showing two distinct notches representing the mesh distortion in its frequency distribution profile.

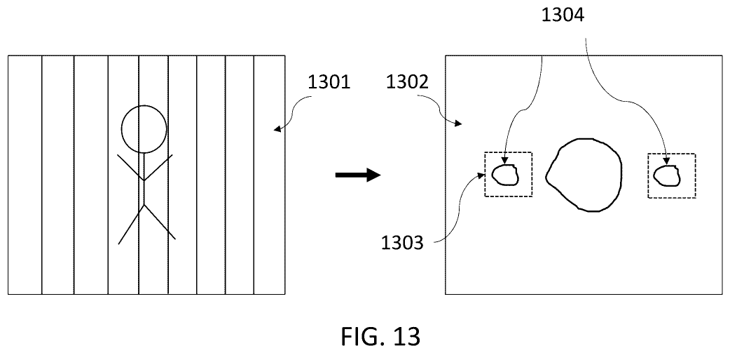

FIG. 13 illustrates a person in front of a display 1301. When a 2D FFT is performed against that spatial image, a spectra image 1302 is created in the frequency domain. The bandpass filter noted above is defined by the dashed line boundary boxes 1303. Boxes 1303 are determined by the area occupied by the two side lobes 1304, representing the encoding of the mesh distortion profile in the 2D spectra.

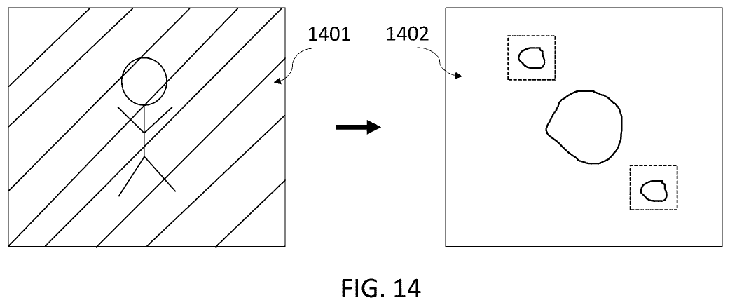

FIG. 14 illustrates when a mesh is oriented diagonally, i.e., at 450 from horizontal, in display 1401. The spectra image in the frequency domain after a 2D FFT transformation is picture 1402. Thus, the region of the mesh spectra profile rotates in direct correlation to the spatial image rotation of the mesh. This discovery helps address different spatial domain distortion patterns based on different mesh designs in a display screen.

In an alternative embodiment of the invention, the 2D FFT transformation is substituted with a direct cosine transformation (DCT) or other transformation capable of achieving 2-D spectra in the frequency domain.

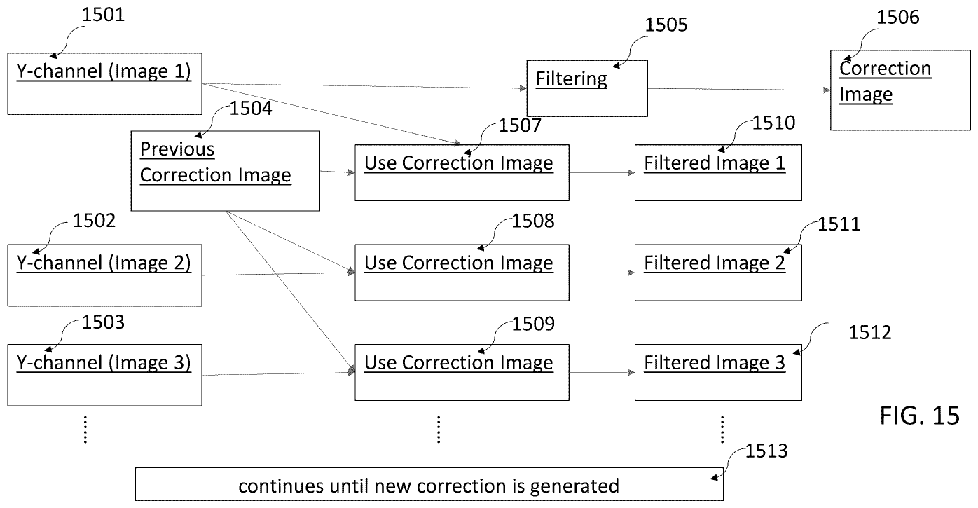

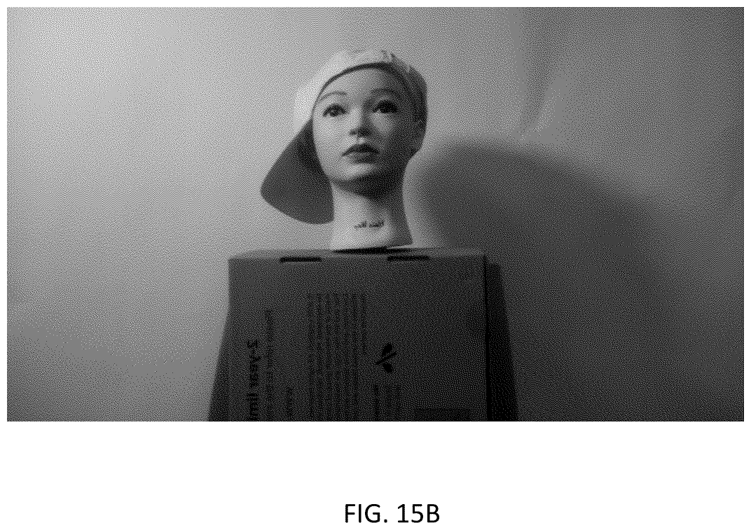

FIG. 15 illustrates applying and reusing a single correction image to a series of captured raw images to avoid overly heavy computation for every frame and ensure a high frame rate display of camera preview images. After filtering 1505 the Y-channel raw image 1501, following the process described above, a correction image 1506 is created. Once this correction image is obtained, it replaces any previously used correction image 1504. The correction image is used as an offset against Y-channel image 1 of 1501 and achieves a filtered image 1 of 1510. Subsequently, instead of filtering and calculating a new correction image for every new frame of a captured image, the inventors discovered that the correction image could be reused due to the fixed nature of the mesh structure and pattern. For a new Y-channel image 2 of 1502, the method applies the same correction image of 1506 as offset at 1508 and achieves filtered image 2 at 1511. Reuse of the correction image of 1506 continues for Y-channel image 3 of 1503 to achieve filtered image 3 of 1512, and so on, until a new correction image is generated at 1513. Reusing a single correction image for a series of image frames reduces computational resources by a dozen times and ensures a high frame rate display of filtered images.

FIG. 15B is a picture of a filtered image free of Moiré Pattern interference and mesh distortion. It reaches a clarity level nearly indistinguishable from a picture captured behind a clear sheet of glass, particularly human perception in everyday video conferencing contexts, where image resolution or fine detail is not the primary concern.

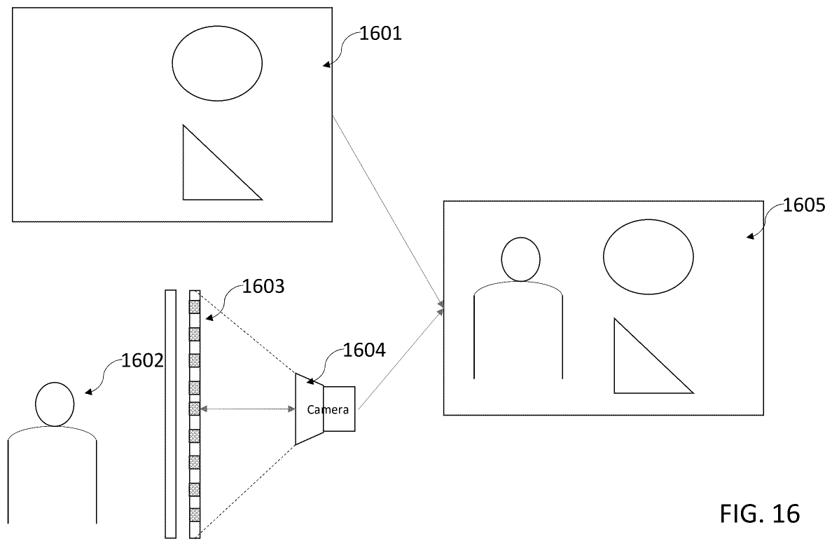

FIG. 16 illustrates a method for constructing a person-embedded view image by combining the camera view of a person in front of the display with digital content shown on the display. In most video applications, digital content 1601 on a computer display is separate from the user's camera view. This is especially the case in video conferencing application windows. Once a screen share is displayed in a video call, the person's view captured by a camera is reduced to a thumbnail view and positioned at a corner of the screen. At the same time, the digital content takes up the majority of the display screen area. In such a prior art environment, the camera view image makes the person appear as if they are looking away instead of at the audience, while in reality, the person is actually looking at the digital content to present the digital content to the audience. The present invention system captures a person image 1602 from behind a display 1603 with a centered behind the display camera 1604 where the person's image appears naturally. The camera then flips the left-right orientation of the person's image to create a mirrored image of the person. The digital content can be made transparent by setting the background color to have a 100% transparent alpha channel, leaving the foreground objects with contrasting and bright colors. The transparent digital content is layered as a superimposing layer on top of the left-right flipped camera view image to achieve a combined image with the person and the digital content embedded together. In this person-embedded view image, the camera correctly captures the person's gaze, pointing, writing, gestures, and expressions. When superimposed with the digital content, the audience sees exactly where the person is gazing, where he is pointing, where and what the person is writing. In the setting of a Zoom or Teams video conference call, the presenter can show the combined view, embedding the person view with the digital content view as a regular camera stream instead of a screen share. This results in a much more natural-looking video, as if the camera is behind a clear sheet of virtual glass, capturing the person's image and the ink the person is writing on the glass.

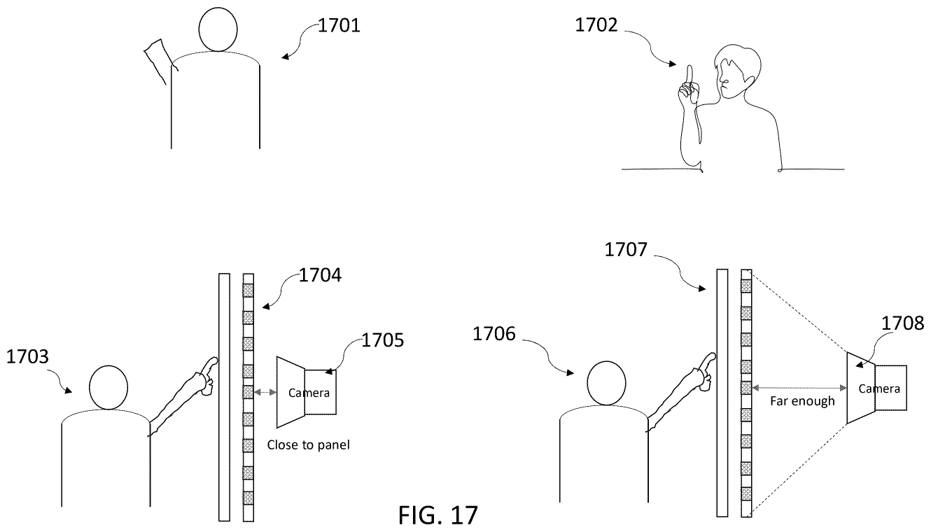

FIG. 17 illustrates the effect of varying the depth of the centered behind the display camera from the back side of the display. As shown on the left side of this figure, camera 1705 is located a short distance from the backside of the display 1704, such as 5-6 centimeters. It will capture most of the person 1703 in front of the display before the person starts to touch the surface to write on it. However, once the person begins writing by touching the display surface, if it's interactive, the person's hand or fingertip may go beyond the FOV of the camera and appear as if the hand is clipped off. At a different distance like that shown on the right, using camera 1708, when the camera is far enough to include the entire backside of the display inside of its FOV, the person's finger, hand, and whole arm are all visible in a person embedded image of both the person and the digital content. In situations such as diagramming out a concept or a design, it could be highly desirable to see the fingertip of the presenter along with a centered view of the presenter, who appears natural in the image. In other situations, simply capturing the realistic view of a person in a video call by having the camera centered behind the display will suffice.

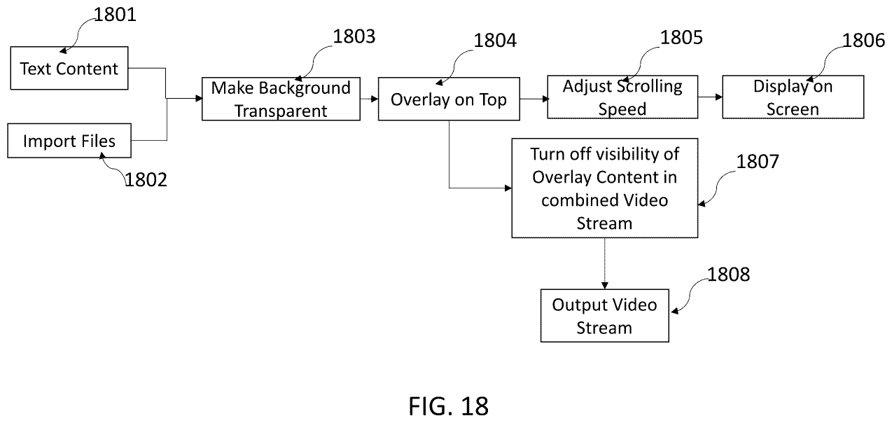

FIG. 18 illustrates a method for applying the system of the present invention as a digital teleprompter. When a script content is acquired in steps 1801 or 1802, the content is made background transparent at step 1803. The digital script content is then placed as an overlay layer on top of a person-embedded image with both the person in front of the display and other digital content presented on the display at step 1804. The script content can automatically scroll to match the person's audio narrative speed at step 1805. The script content is visible in step 1806 and can be used as a confidence monitor. For any video recording or for presenting in a video conference call setting, the overlay content is set to be invisible to the recorded or transmitted video stream at 1807 and 1808.

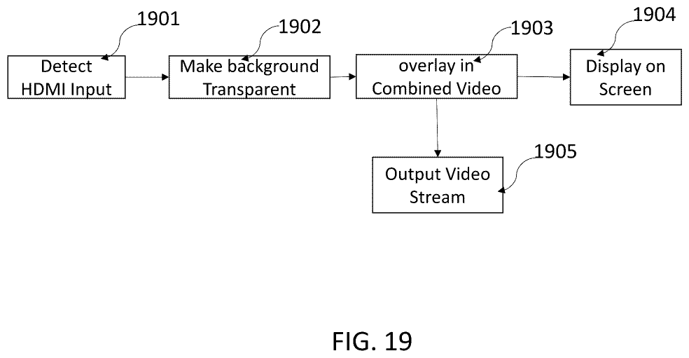

FIG. 19 illustrates a method where the system of the present invention is used as a second monitor for an external computer. The processor of the present invention detects external input sources through an HDMI input port at step 1901. Due to the nature of the HDMI connection industry standard, the external computer would automatically recognize the system of the present invention as a connected monitor. The external computer will then output an HDMI video stream. The system of the present invention accepts the HDMI video stream input and makes the video stream background transparent, leaving the foreground in high contrast and bright colors at step 1902. The input HDMI video stream is then combined with or overlaid at step 1903 on top of local digital content on the system's display combined with the person-embedded view image already combining a person's camera view with local digital content.

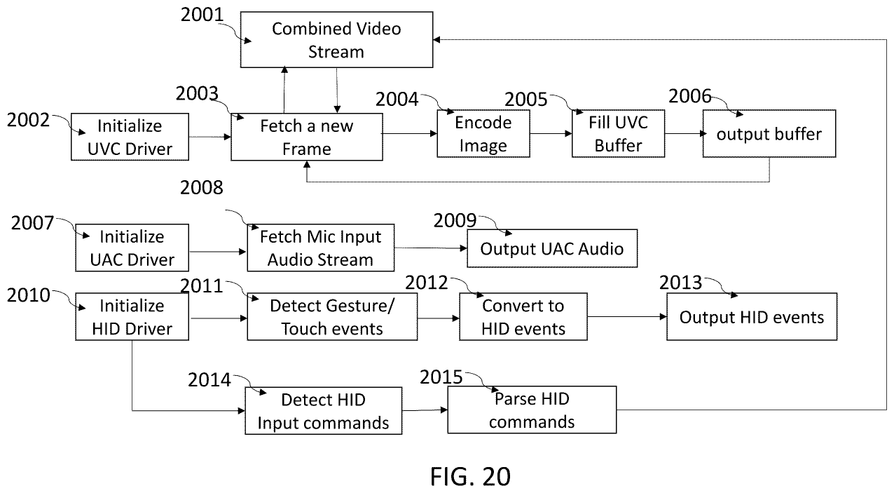

FIG. 20 illustrates a method where the system of the present invention functions as a simple webcam for an external computer. An external computer can bring in the entire person-embedded view image of the system as a webcam and let the webcam UVC stream appear in a video conference call as if the system is a simple webcam. The natural appearance of the user and the combined digital content improves the video conference significantly. To accomplish this, the system's processor initializes a UVC driver 2002, a UAC driver 2007, and a HID driver 2010. The processor fetches a new image from the person-embedded image stream 2001 just constructed through previous methods described above, at 2003. The method encodes the fetched image using a CODEC at 2004, fills a UVC buffer at 2005, and outputs with encoded UVC data format through an output buffer in 2006 via a USB OTG port such as 809 of FIG. 8B. For audio stream output, the processor fetches a microphone input audio stream at step 2008, then encodes the audio using an audio CODEC, and outputs UAC formatted audio stream via a USB OTG port such as 809. For HID event data, the processor detects events from gesture recognized, touch events, keyboard, trackpad, or mouse events in step 2011, then encodes into USB HID event data format at step 2013, and outputs through a USB OTG output port like 809.

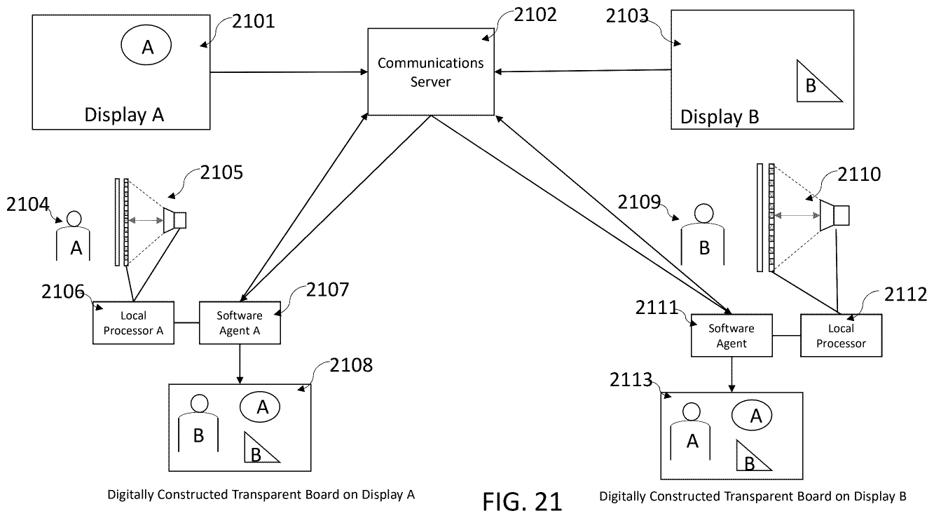

FIG. 21 illustrates a collaborative video communication system that incorporates a cloud-based communications server to facilitate the system in FIG. 16 to work with the same remote system to combine the person-embedded image view with a shared digital virtual glass board. In such a system, both parties of the video conference communication see the other party's person-embedded view images while sharing a transparent digital “glass” board so that each party can write or add digital content to the commonly shared board. Each party can see in the person-embedded view exactly where the other party is pointing or where or what the other party is writing.

Using the system of FIG. 16, system A, a circle is displayed on display A of system A to form a digital content view A at 2101. Also, in system A, person A is in front of display A, with a behind display center camera at 2105 producing a person A embedded digital view A. Furthermore, a local processor A controls the processes in system A, working with a software agent A at 2107. In a remote second system, using the same system of FIG. 16, system B, a triangle is displayed on display B of system B to form a digital content view B 2103. Also, in system B, person B 2109 is in front of display B 2110, with a camera behind the display to produce person B embedded digital view B. Furthermore, a local processor B 2112 controls the processes in system B, working with a software agent B, at 2111. The effect of this communications system is that person A 2104 will view the digital view A+B with person B embedded as in 2108, while person B 2109's view is a constructed digital view A+B with person A embedded as in 2113.

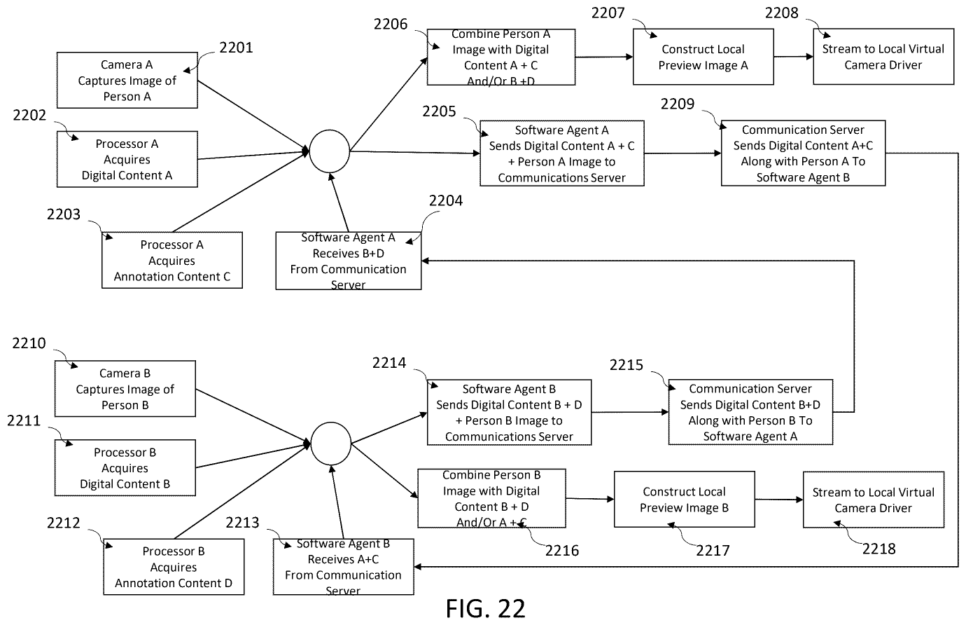

FIG. 22 illustrates the method for the system in FIG. 21, enabling two parties, person A and person B, to collaborate via a communications server with person-embedded view images of each other in a constructed digital image sharing a digital virtual glass board with each other's person view embedded. In system A, camera A captures person A image at 2201. Processor A acquires digital content A image at 2202, accepts new annotation C at 2203, and receives through software agent A from the communications server of digital content B+D at 2204. Processor A combines person A image with digital content A+C+B+D image into a person A embedded digital view A at 2206. Processor A stream constructs person A embedded digital view A to local virtual camera preview driver at 2208. Processor A sends person A image, digital content A+C+B+D, and person A embedded digital view A to the communications server at 2209. The communications server sends those three distinctive image streams to software agent B at 2213. System B performs the reciprocal actions of system A, and processor B sends its respective three image streams to the communications server, which sends the system B side streams to software agent A at 2204. Both sides see the same virtual glass board with all digital content A+B+C+D. Person A will see a person B embedded digital image with A+B+C+D, and person B will see a person A embedded digital image with content A+B+C+D.

In further embodiments of the invention, the T.OLED is replaced with a video projector and a transparent projection screen of clear material such as but not limited to glass or acrylic with a higher degree of transparency, i.e., at a minimum of 25% transparency but preferably more than 40% and as high as 90% to 92%. In a preferred embodiment, the video projector is a short throw projector or ultrashort throw projector that projects a video image of digital media content onto the transparent projection screen at a distance that facilitates a projection angle of less than 45 degrees relative to horizontal. The identification and implementation of the short throw projector or ultra short throw (UST) projector are apparent to one of ordinary skill in the art. A behind-display camera captures a video image through the transparent projection screen of the user located on the front side of the screen. Such a passive transparent display screen configuration improves user image capture because the distortion associated with a T.OLED is significantly reduced if not eliminated.

To optimize the brightness of the projected video image (as viewed by the user) while preventing the behind-display camera from capturing that same projected video image transmitted through the screen, a series of optical layers in the form of films and/or coatings are included in the optical path between the projector and the camera. The series of optical layers may comprise a first linear polarizer, a partially reflective layer or dispersion layer, and a second linear polarizer. The first and second linear polarizers are orthogonal to one another, i.e., their axes are oriented 90 degrees to one another to block the projected image from being received by the camera. In a front projection arrangement, the partially reflective layer is designed to reflect a bright projected image to the user while permitting ambient light on the user's side to transmit to the camera. In a rear projection arrangement, the dispersion layer is designed to transmit a bright projected image to the user while permitting ambient light on the user's side to transmit through to the camera. In contrast to T.OLED and Transparent MicroLED display screens, the transparent projection screen can only reflect or scatter light but can not actively emit light by itself. The use of a projector is therefore necessary. The partially reflective layer can be a multilayer dielectric coating, a single layer made of an optical material with a substantially different refractive index, or a metal or alloy coating. The dispersion layer may comprise metal particles such as silver or crystals to disperse light. The inventors achieved a 95%-99% clear camera image (relative to capturing an image through a clear sheet of glass) when the transparent display screen with the dispersion layer had only a 60% degree of transparency.

When the projector projects light onto the front of the screen, the resulting image is never as bright as viewing a light emitting active display. To display a bright and clear picture on the screen, the injection angle for incoming light from the projector should be as straight as possible. When the light is injected at more than 70 degrees from the horizontal, the image is severely dimmed. Such dimming would make the resulting display undesirable and infeasible for widespread or commercial use.

The UST projector is desirable for compactness and aesthetics in a preferred embodiment. UST projectors will likely inject light at greater than a 70-degree angle. A regular or short-throw projector will produce much brighter images with even brightness across the entire surface. However, they require a significant distance between the projector lens and the display surface. The form factor may not fit on a user's desk when attempting to create a video conferencing device using the passive display screen and a short-throw projector.

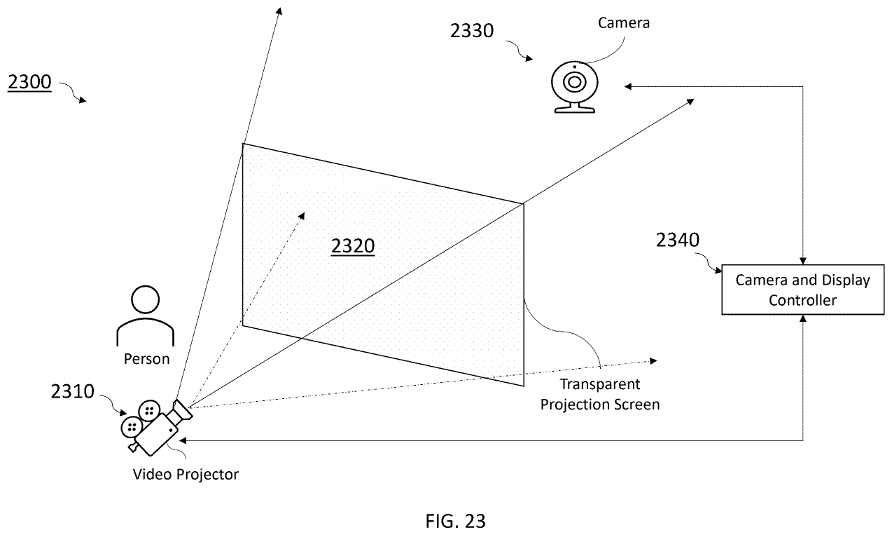

FIG. 23 illustrates a front projection transparent display system 2300 according to an embodiment of the invention. In this arrangement, a projector 2310 is disposed on the front or same side of the user (“person”). A transparent projection screen 2320 is located in between the projector 2310 and a behind-display camera 2330. As discussed above, the transparent projection screen includes a partially reflective layer on its front side, which faces the projector 2310 and the user. In this core configuration, a portion of the video image projected onto screen 2320 by the projector 2310 will transmit through the screen 2320, if untreated, and reach the lens of the behind-display camera 2330. For video conferencing or video recording purposes, it is more desirable for the camera 2330 not to “see” any projected content. Instead, the camera 2330 is expected to see through the screen and only capture an image of the user and the user's environment. In real-time or near real-time, the video stream captured by the camera 2330 with the user is combined to embed the person's image with the projected digital content to form a presenter-embedded image. Such a front projection arrangement provides the user with the brightest image as the nature of the transparent screen is brighter on the front side of screen 2320, where the projector 2310 is casting light.

Camera and display controller 2340 is an optional processor that can implement the black line insertion and rolling shutter processes described above to remove distortion and interference as described above. However, in projector embodiments, the controller 2340 controls the projector 2310 rather than a T.OLED. In an alternative embodiment of the invention, the polarized layers are not included, and controller 2340 performs black line insertion as described above. For example, the controller 2340 inserts black lines within an interval of 6 ms to 14 ms or at 70 Hz to 120 hz to eliminate bleed-through light captured by the camera.

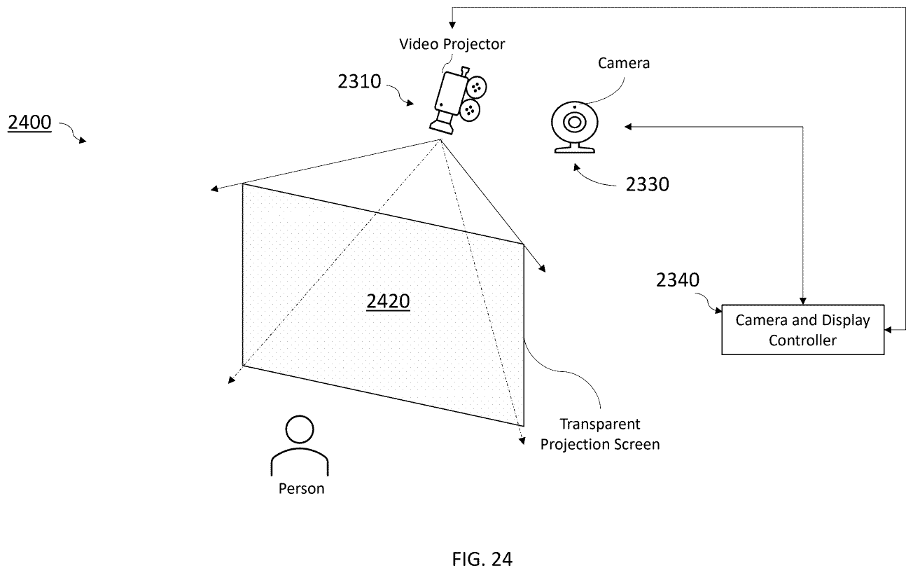

FIG. 24 illustrates a rear projection transparent display system 2400 according to an embodiment of the invention. In this arrangement, the projector 2310 is disposed on the rear or back side of a transparent screen 2420 and on the same side as the behind-display camera 2330. The “rear” surface of a transparent screen 2320 may optionally include a dispersion layer facing the projector 2310 and the camera 2330. In this configuration, the projected light showing digital media content “bleeds” through screen 2320, if untreated further, and typically illuminates and projects the same digital content in larger size onto the viewer's body, which is then captured by the camera 2330 back through the screen. The inventors consider preventing the camera 2330 from “seeing” the projected content desirable. Therefore, camera 2330 is called a “see-through” camera and only captures only the user's image and objects in the user's surrounding environment within view. In real-time or near real-time, this video stream with the user can be combined to embed the person's image with the digital content in a separate software application to form a presenter-embedded image. Such a rear projection arrangement provides the camera with the brightest image as the projector 2310 is casting light on the same side of the screen 2320.

Whether a front or rear projection arrangement, it is desirable for the camera 2330 to “see through” the screen 2320 without imaging any projected digital content from the projector 2310. To accomplish this goal, a pair of orthogonal linear polarizers are introduced into the optical path between the video projector 2310 and the camera 2330, as described below.

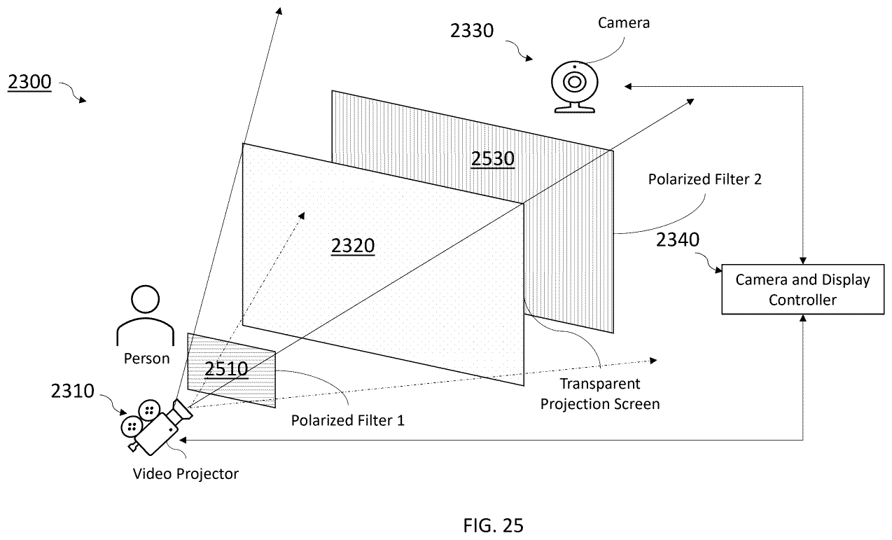

FIG. 25 illustrates the front projection transparent display system 2300 according to an embodiment of the invention. Here, a first polarized filter 2510 is placed in front of or coated on a lens of the projector 2310, and a second polarized filter 2530 is placed immediately behind the transparent projection screen 2320 with a polarization that is orthogonal to the polarization of the first polarized filter 2510.

For example, the light projected out of the projector 2310 lens is filtered by the first polarized filter 2510 with a horizontal polarization, which removes vertical polarization components. When this filtered light reaches the projection screen 2320 surface, digital images are visible to the viewer at about half the original image brightness. However, it will be eliminated once the remaining 50% of light passes through to the second polarized filter 2530 with a vertical polarization. Yet, because the first polarized filter 2510 is not in the optical path of the ambient light of the user and the user's surroundings, it is transmitted through the second polarized filter 2530 to the camera 2330. Because polarization is never 100% horizontal or vertical or the two polarizers 2510 and 2530 can be oriented exactly perpendicular, a tiny amount of projected light always leaks through to the camera 2330. A 1% or 2% leakage is quite common but remains acceptable as it is not perceptible to the human eye in the captured image. When placed adjacent to the rear surface of the second polarized filter 2530 if a film, or if the second polarized filter 2530 is coated onto its lens, the camera 2330 can “see-through” the rear of the transparent display screen 2320 to the front area with the user. Again, the camera 2330 captures only the user's image and surroundings as if there was no projection screen 2320 displaying projected digital content sitting in between. Such a result is beneficial for video conferencing and capturing presentations with the user shown facing the camera 2330.

The use of polarized filters reduces, if not eliminates, the need for the black line insertion and rolling shutter processes described above. If implemented, that process only requires lightweight calculations for simple digital filtering because the distortion is not as strong as with a T.OLED. There is no active LED matrix in the transparent projection screen to account for. Such reduced computation workload is beneficial because dedicated embedded processing, which is cost-prohibitive in many cases, is unnecessary. Yet, implementing polarized filters sacrifices projected image brightness by as much as 50%. Accordingly, the brightness of the projector 2310 must be at least 1500 lumens, preferably above 3,000 lumens, for optimal perception of the projected image by the user. Projectors with even higher brightness may be undesirable for video conferencing because they are generally bulky, likely to get hot, and require noisy fans to cool.

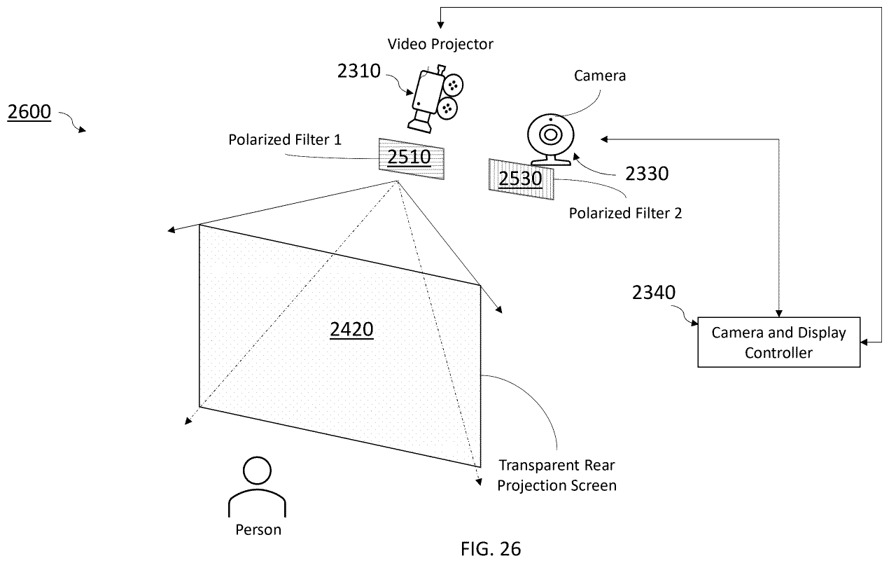

FIG. 26 illustrates the rear projection transparent display system 2400 according to an embodiment of the invention. Here, the first polarized filter 2510 is placed in front of or coated on a lens of the projector 2310, and a second polarized filter 2530 is placed in front of or coated on a lens of the camera 2330. Yet, the first polarized filter 2510, and the second polarized filter 2530 are located on the rear side of the transparent projection screen 2420. The user sees the projected image on the transparent projection screen 2420, but the camera 2330 does not. The camera 2330 sees only the user. The transparent display screen 2420 comprises a dispersion layer in the form of a film or coating on its rear surface. The dispersion layer disperses light from the projector 2530. The scattered light is transmitted to the user through the transparent display screen 2420.

Brightness degradation caused by the acute angle of the light injection by the projector 2310 is significantly worsened away from the center of the display screen 2420 and near its outer frame or periphery. This is likely caused by the increase in injection angle when light reaches these outer areas. For example, at a 70-degree injection angle, light reaches the outer frame of the top edge area of a 16:9 display at an angle of 86 degrees. In this case, light dispersion by metal or crystal particles in the dispersion layer travels away from the user's front view angle and gets deflected in various tangential directions. As a result, the projected image appears brighter near the center of the display screen 2420 and noticeably dimmer toward the outer perimeter. Such uneven display brightness is unacceptable for practical use.

The inventors have discovered that a dispersion layer comprising metal particles sputtered onto a film disperses sufficient light to the user when particle density is high enough. The more acute the light injection angle, the higher the density of particles required. However, higher density comes at the price of losing transparency. Transparency is only possible when particles occupy a relatively small percentage of the surface area but are evenly spread out. Intuitively, higher particle deposition density leads to a higher percentage of light dispersing but is less transparent for ambient light to travel through. In an extreme case where metal particles cover the entire surface at 100%, the display is at the maximum brightness while transparency is nearly 0%. The inverse relationship between dispersion brightness and transparency can be exploited as follows.

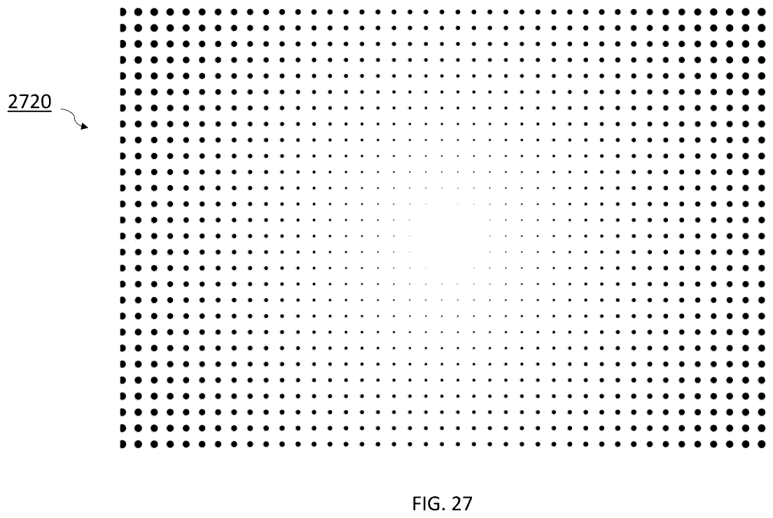

In an embodiment of this invention, the density of particles in the dispersion layer varies. For example, as shown in the dispersion layer 2720 of FIG. 27, the density of metal particles (illustrated by solid circles) increases linearly or geometrically relative to the distance from the center of the display screen 2420 while directing the camera 2330 toward its center. In such a configuration, brightness degradation caused by higher injection angle acuteness is compensated by the higher density of light-dispersing particles deposited at the outer region. This makes it possible for the displayed image to appear evenly bright in the outer and center areas. In this construct, transparency is the highest at the center and lowest at the outermost perimeter. Particle density is the lowest at the center and highest at the outermost perimeter. Such an inverse relationship between density and transparency of the display material ensures even brightness across the entire surface, with the center being highly transparent and the edge regions with significantly lower transparency but high display brightness.

Referring back to FIG. 26, the camera 2330 is behind the display screen 2420 on the rear side. Its function is to capture a regular portrait video stream for the user in front. Again, the desire is not to let the camera 2330 “see” anything that is displayed by the projector 2310 on screen 2420, meaning the user sees projected content with the maximum brightness and clarity, while the camera 2330 sees the viewer clearly as if it is seeing through a sheet of completely clear glass. With the camera 2330 disposed in the center region on the rear side, almost immediately next to the display screen 2420 itself, it enjoys the highest level of transparency, free from suffering low transparency near the outer region. Such a rear configuration allows a UST projector to enable a compact and aesthetically pleasing industrial design with even and bright projected content on a passive display screen while achieving a clear camera image capturing as if it is seeing through a completely clear glass.

In yet another embodiment, the camera and display controller implement machine vision processing to identify a person and subsequently move the camera 2330 with x-axis and y-axis movements to always directly face the person even when the person moves around within the frame.

The invention has been described herein using specific embodiments for illustration only. However, it will be readily apparent to one of ordinary skill in the art that the invention's principles can be embodied in other ways. Therefore, the invention should not be regarded as limited in scope to the specific embodiments disclosed herein; it should be fully commensurate in scope with the following claims.

We claim:

1. A system for video conferencing and collaborative communication comprising:
a transparent display screen,
a projector disposed on a front side or rear side of the display screen,
a camera disposed on a rear side of the display screen, and
a controller that synchronizes light projected by the projector with a sensor of the camera.

2. The system of claim 1, wherein the sensor of the camera is a rolling shutter configured to open and capture one scan line of the light projected by the projector.

3. The system of claim 2, wherein the light projected by the projector refreshes at a rate of at least 70 Hz.

4. The system of claim 2, wherein the light projected by the projector comprises a black frame inserted every 14 ms or less.

5. The system of claim 4, wherein the sensor of the camera is opened every 14 ms or more in synchronization with the black frame inserted every 14 ms or less.

6. The system of claim 1, wherein the controller controls a frequency of the light projected by the projector and a frequency and a duration of an opening of the sensor of the camera.

7. A system for video conferencing and collaborative communication comprising:
a transparent display screen,
a projector disposed on a rear side of the display screen,
a camera display on the rear side of the display screen, and
a controller configures to synchronize the projector's black line insertion with a sensor of the camera.

8. The system of claim 7, wherein the sensor is a rolling shutter configured to open and capture one scan line of the light projected by the projector.

9. The system of claim 7, wherein the light projected by the projector comprises a black frame inserted every 14 ms or less.

10. The system of claim 9, wherein the sensor of the camera is opened every 14 ms or more in synchronization with the black frame inserted every 14 ms or less.

11. The system of claim 7, wherein the controller controls a frequency of the light projected by the projector and a frequency and a duration of an opening of the sensor of the camera.

12. A system for video conferencing and collaborative communication comprising:
a transparent display screen,
a projector disposed on a rear side of the transparent display screen,
a camera disposed on the rear side of the transparent display screen,
a first polarized filter disposed between the transparent display screen and the projector,
a second polarized filter disposed between the camera and the transparent display screen, wherein the first polarized filter's transmitting axis is perpendicular to the second polarized filter's transmitting axis.

13. The system of claim 12, wherein the camera comprises a rolling shutter, an opening of which is synchronized with the projector.

14. The system of claim 12, wherein the transparent display screen is a passive material.

15. The system of claim 12, wherein the transparent display screen has a transparency of at least 25%.

16. The system of claim 13, wherein the rolling shutter is operated to permit the camera to capture images at a rate of at least 70 frames per second.

17. The system of claim 13, wherein the projector is configured to project light comprising a progressive scan with one or more black lines synchronized with a corresponding position of the rolling shutter.

18. The system of claim 17, further comprising a processor configured to apply a filter, in a frequency domain, to a Y-channel of an image captured by the camera during insertion of the one or more black lines.

19. A system for video conferencing and collaborative communication comprising:
a transparent display screen,
a projector disposed on a back side or a rear side of the transparent display screen,
a camera disposed on the rear side of the transparent display screen,
a first polarized filter disposed between the projector and the transparent display screen, and
a second polarized filter disposed between the camera and the transparent display screen, wherein the first polarized filter's transmitting axis is perpendicular to the second polarized filter's transmitting axis.

20. The system of claim 19, wherein the camera comprises a rolling shutter, an opening of which is synchronized with the projector.

21. The system of claim 19, wherein the transparent display screen is a passive material.

22. The system of claim 19, wherein the transparent display screen has a transparency of at least 25%.

23. The system of claim 20, wherein the rolling shutter is operated to permit the camera to capture images at a rate of at least 70 frames per second.

24. The system of claim 20, wherein the projector is configured to project light comprising a progressive scan with one or more black lines synchronized with a corresponding position of the rolling shutter.

25. The system of claim 24, further comprising a processor configured to apply a filter, in a frequency domain, to a Y-channel of an image captured by the camera during insertion of the one or more black lines.
